(19) United States
(12) Patent Application Publication
(10) Pub. No.: US 2026/0008440 A1
(43) Pub. Date: Jan. 8, 2026

(54) DETECTION OF YAW INSTABILITIES IN VEHICLE COMBINATIONS

(71) Applicant: VOLVO TRUCK CORPORATION, Göteborg (SE)

(72) Inventors: Umur ERDINC, Göteborg (SE); Mats JONASSON, Partille (SE); Bengt JACOBSON, Mölnlycke (SE)

(73) Assignee: VOLVO TRUCK CORPORATION, Göteborg (SE)

(21) Appl. No.: 18/992,733

(22) PCT Filed: Jul. 15, 2022
(86) PCT No.: PCT/EP2022/069957

§ 371 Date: Jan. 9, 2025

(51) Int. Cl. B60T 8/17; B60T 8/1755; B60T 8/1761; B60T 8/24

(52) U.S. Cl. CPC B60T 8/1708; B60T 8/17551; B60T 8/17616; B60T 8/248; B60T 2230/06; B60T 2240/02

(57) ABSTRACT

A method detects a yaw instability in a vehicle combination. The vehicle combination has a tractor unit and at least one trailing unit. The method includes determining a current value of a longitudinal slip of at least one wheel of at least one unit of the vehicle combination, comparing the current value of the longitudinal slip to a threshold, and, if the current value is beyond the threshold, determining that an upcoming or ongoing yaw instability is present in the vehicle combination.

### FIELD

This disclosure relates to detection of unsafe operation in vehicle combinations. In particular, it relates to detection of yaw instabilities for combinations of at least two vehicle units.

### BACKGROUND

Multi-unit vehicle combinations are prone to different modes of unsafe operation including jack-knifing, trailer swing, rollover and off-tracking. Two of these, jack-knifing and trailer swing, can be grouped under the umbrella of yaw instabilities, as they are predominantly embodied in the yaw behaviour of the tractor and trailing units of a vehicle combination.

Jack-knifing occurs when the tractor unit of a vehicle combination starts to skid sideways in slippery road conditions and the driver is not able to correct the skidding in time with the proper amount of steering. The trailing unit pushes the tractor unit causing the tractor unit to turn around a vertical axis until it hits the trailing unit. Jack-knifing is one of the major sources of accidents in multi-unit vehicle combinations. Trailer swing occurs when the wheels of the trailing unit slip, for example due to slippery road conditions, while the wheels of the tractor unit do not. In this case, the trailing unit starts to swing around the vertical axis. All types of vehicle combinations are susceptible to such instabilities.

These instabilities can be exacerbated by the presence of propulsive elements, for example motors or braking systems, on the trailing unit. Such elements are used increasingly as electric vehicles become more popular. For example, electric motors may be present on some or all axles of the different units. In some instances, a controller of such a vehicle may activate the electric motors of only one axle or unit in order to propel the vehicle. For example, the controller may activate only the electric motors of a trailing unit if the battery of the tractor unit is emptier or if the tractor unit is a conventional tractor unit and the trailing unit is an electric trailer. Electric axles may also be used to capture energy via regenerative braking. A controller may cause only one axle or unit to perform regenerative braking without braking the other axles or units, for example if the battery of one unit is much emptier than the battery of another unit. Propelling or braking with only one axle or unit may create the conditions for yaw instabilities more readily than conventional ways of propelling and braking. To avoid such situations, it is important to detect such yaw instabilities either in advance or at an early point of onset.

### SUMMARY

This disclosure attempts to solve the problems noted above by providing a method of detecting a yaw instability in a vehicle combination. In particular, a longitudinal slip of at least one wheel of at least one unit of the vehicle combination can be monitored with respect to a threshold to determine if the vehicle combination is operating in a safe manner. The threshold can be set based on a current operating state of the vehicle combination.

The method allows an upcoming or ongoing yaw instability in a vehicle combination to be detected with high accuracy and at an early stage. The longitudinal slip of a given wheel gives good certainty on whether a jack-knife or trailer swing is taking place. The method only requires monitoring of a single unit, and does not require any monitoring of the articulation angle, meaning that this finding can be applied to vehicle combinations with trailers lacking sensors. By determining thresholds for safe operation dynamically based on a current operating state of a vehicle combination, a more robust and responsive detection method is provided. In particular, changes in operating conditions that affect the likelihood of a yaw instability occurring, for example vehicle speed and road wheel angle, can be taken into account. This ensures that instabilities that might not be captured by a fixed safe operating envelope can be detected properly. In the opposite sense, false detections of instability captured by an inappropriately set safe operating envelope are avoided.

According to an aspect, there is provided a method of detecting a yaw instability in a vehicle combination, the vehicle combination comprising a tractor unit and at least one trailing unit, the method comprising determining a current value of a longitudinal slip of at least one wheel of at least one unit of the vehicle combination, comparing the current value of the longitudinal slip to a threshold, and if the current value is beyond the threshold, determining that an upcoming or ongoing yaw instability is present in the vehicle combination.

Optionally, the method comprises determining the current value of the longitudinal slip using one or more sensors on the vehicle combination. Optionally, the current value of the longitudinal slip is a maximum longitudinal slip value or an average longitudinal slip value determined from longitudinal slip values from a plurality of wheels. Optionally, the method comprises determining that an upcoming or ongoing yaw instability is present in the vehicle combination if the current values of longitudinal slip of a plurality of wheels are all beyond the threshold. Optionally, the threshold is a fixed threshold determined based on the slip ratio of the wheel at a maximum longitudinal tyre force. Optionally, the slip ratio is dependent on the tyre type and/or a road surface friction coefficient. Optionally, the threshold is a variable threshold determined based on the inverse of a current value of a lateral acceleration of the tractor unit, a lateral acceleration of the trailing unit, a road wheel angle of the tractor unit, a road wheel angle of the trailing unit, and/or an articulation angle of consecutive units.

Optionally, the method comprises determining that a jack-knife is present in the vehicle combination if the current value of the longitudinal slip of at least one wheel of the tractor unit is beyond the threshold. Optionally, the method comprises determining that trailer swing is present in the vehicle combination if the current value of the longitudinal slip of at least one wheel of the trailing unit is beyond the threshold. Optionally, the method comprises determining that a complete swing out is present in the vehicle combination if the current values of the longitudinal slip of at least one wheel of the tractor unit and at least one wheel of the trailing unit are beyond respective thresholds.

According to an aspect, there is provided a method of detecting a yaw instability in a vehicle combination, the vehicle combination comprising a tractor unit and at least one trailing unit, the method comprising receiving data indicating an activation state of an anti-lock braking system “ABS”, a traction control system and/or an electronic stability program “ESP” associated with at least one wheel of at least one unit of the vehicle combination, if the data indicates that the ABS, the traction control system and/or the ESP is activated, determining that an upcoming or ongoing yaw instability is present in the vehicle combination.

Optionally, the method comprises determining that an upcoming or ongoing yaw instability is present in the vehicle combination based on a current value of a lateral acceleration of the tractor unit, a lateral acceleration of the trailing unit, a road wheel angle of the tractor unit, a road wheel angle of the trailing unit, and/or an articulation angle of consecutive units.

Optionally, the method comprises determining that a jack-knife is present in the vehicle combination if the data indicates that the ABS, the traction control system and/or the ESP associated with at least one wheel of the tractor unit is activated. Optionally, the method comprises determining that trailer swing is present in the vehicle combination if the data indicates that the ABS, the traction control system and/or the ESP associated with at least one wheel of the trailing unit is activated. Optionally, the method comprises determining that a complete swing out is present in the vehicle combination if the data indicates that the ABS, the traction control system and/or the ESP associated with at least one wheel of the tractor unit is activated and that the ABS, the traction control system and/or the ESP associated with at least one wheel of the trailing unit is activated.

According to another aspect, there is provided computer-readable medium having stored thereon instructions that, when executed by one or more processors cause execution of the method steps.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. Further features of, and advantages with, the present invention will become apparent when studying the appended claims and the following description. The skilled person realizes that different features of the present invention may be combined to create embodiments other than those described in the following, without departing from the scope of the present invention.

### BRIEF DESCRIPTION OF THE DRAWINGS

Exemplary embodiments of the disclosure shall now be described with reference to the drawings in which:

FIG. 1 shows an example vehicle combination;

FIG. 2A shows jack-knifing of a vehicle combination;

FIG. 2B shows trailer swing in a vehicle combination;

FIG. 3 shows an example unit axis system for modelling a vehicle combination;

FIG. 4A shows a generic kinematic model of two units of a vehicle combination;

FIG. 4B shows a kinematic model of a vehicle combination comprising a tractor unit and a trailing unit;

FIG. 5A is a plot of the longitudinal slip for each wheel of a vehicle combination for a jack-knife case;

FIG. 5B is a plot of the longitudinal slip for each wheel of a vehicle combination for a trailer swing case;

FIG. 6A is a plot of longitudinal tyre force on the ground against the slip ratio for different values of the road friction coefficient;

FIG. 6B is a plot of longitudinal and lateral tyre force on the ground against the slip ratio;

FIG. 7 is a flow chart illustrating a first method of detecting a yaw instability in a vehicle combination;

FIG. 8 is a flow chart illustrating a second method of detecting a yaw instability in a vehicle combination;

FIG. 9 is a block diagram illustrating an exemplary computer system in which embodiments of the present disclosure may be implemented.

### SPECIFIC DESCRIPTION

The invention will now be described more fully hereinafter with reference to the accompanying drawings, in which certain aspects of the invention are shown. The invention may, however, be embodied in many different forms and should not be construed as limited to the embodiments and aspects set forth herein; rather, the embodiments are provided by way of example so that this disclosure will be thorough and complete, and will fully convey the scope of the invention to those skilled in the art. Accordingly, it is to be understood that the present invention is not limited to the embodiments described herein and illustrated in the drawings; rather, the skilled person will recognize that many changes and modifications may be made within the scope of the appended claims. Like reference numerals refer to like elements throughout the description.

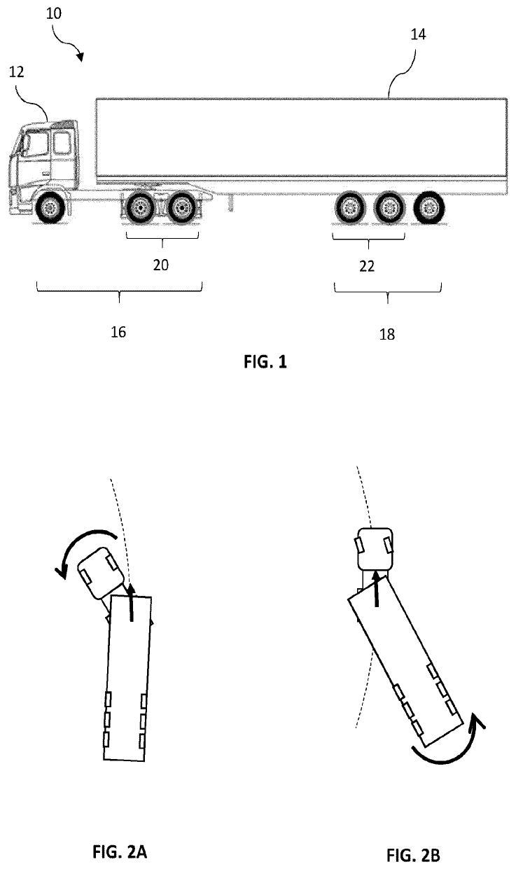

FIG. 1 shows an example vehicle combination 10 of the type considered in this disclosure. The vehicle combination 10 comprises a tractor unit 12 and at least one trailing unit 14. The tractor unit 12 is generally the foremost unit in a vehicle combination, and comprises the cabin for the driver, including steering controls, dashboard displays and the like. Generally, the tractor unit 12 is used to provide propulsion power for the vehicle combination 10. The at least one trailing unit 14 is generally used to store goods that are being transported by the vehicle combination. The at least one trailing unit 14 may be a truck, trailer, dolly and the like. The at least one trailing unit 14 may also provide propulsion to the vehicle combination 10. For example, the trailing unit 14 may comprise one or more electric motors configured to drive one or more axles or individual wheels of the trailing unit 14. A trailing unit 14 without a front axle is known as a semi-trailer.

A vehicle combination 10 may be defined by physical properties of the various units, for example a geometry of each unit and the combination as a whole, a number of axles on each unit, a distance between the axles on each unit, a number of motion support devices (including, for example, electric motors, mechanical service brakes and steering actuators) on each unit, a cornering stiffness on the tyres of each unit, an inertia about a yaw-axis of each unit, an electric motor peak torque output on each unit, an axle load on the axels of each unit.

In the example of FIG. 1, the tractor unit 12 comprises a number of tractor axles 16, and the trailing unit 14 comprises a number of trailer axles 18. At least one of the axles on each unit may be a driven axle, meaning that it is coupled to a propulsion system to drive the vehicle combination 10 forward. The propulsion systems may include traditional propulsion systems coupled to driven axles of the tractor unit 12, and/or electric motors coupled to driven axles of the tractor unit 12 or the trailing unit 14. For example, the three tractor axles 16 may comprise two driven tractor axles 20, and the three trailer axles 18 may comprise two driven trailer axles 22. A unit may be designated by the combination of axles present. In the example of FIG. 1, the vehicle combination 10 comprises a “6×4” tractor unit 12 and a “6×4” trailing unit 14, meaning each unit has six wheels, four of which are driven.

Whilst three tractor axles 16 and three trailer axles 18 are shown, it will be appreciated that any suitable number of axles may be provide on the tractor unit 12 and the at least one trailing unit 14. It will also be appreciated that any number of the tractor axles 16 and/or trailer axles 18 may be driven axles, including zero (i.e. one of the units may include at least one driven axle while the other does not). Furthermore, further trailing units 14 may be provided connected to each other. This gives rise to different types and designations of vehicle combinations.

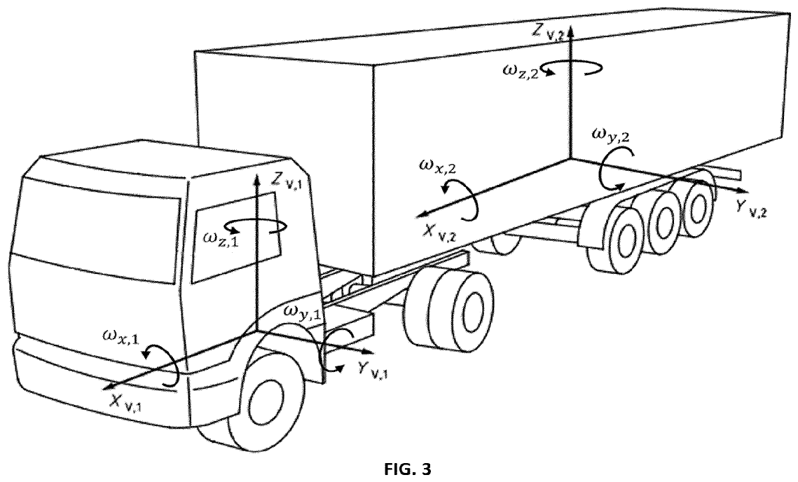

In order to detect yaw instabilities, proper definitions the unsafe behaviour modes are required. The unsafe behaviour modes that are considered as yaw instabilities are in FIGS. 2A and 2B. FIG. 2A shows jack-knifing the wheels of the tractor unit 12 slipping. In particular, the wheels on the two rear axles of the tractor unit 12 slip while the wheels on the trailing unit 14 do not slip, causing a jack-knife. FIG. 2B shows trailer swing due to the wheels of the trailing unit 14 slipping. In particular, the wheels on the trailing unit 14 slip while the wheels on the tractor unit 12 do not slip, causing trailer swing. An unsafe mode where both jack-knifing and trailer swing occur may be known as a complete spin out.

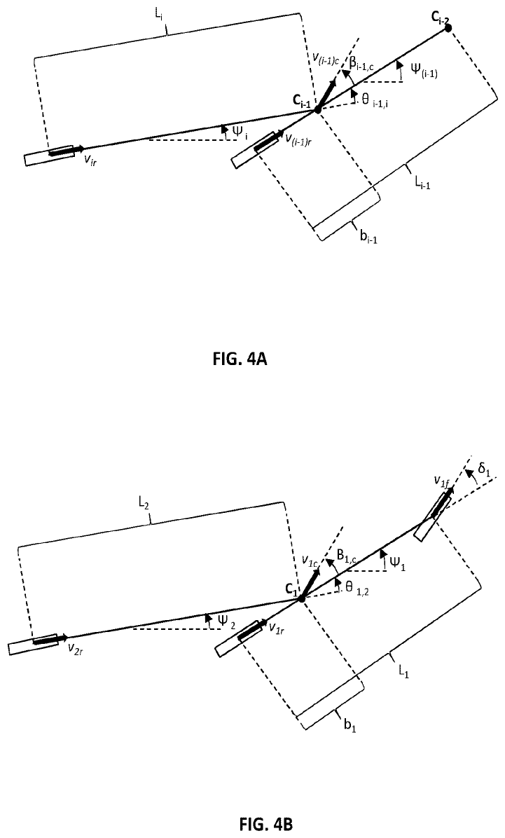

FIGS. 3 and 4 show examples of how the dynamics of a vehicle combination 10 can be modelled. In order to describe motion and dynamics of the different vehicle units a definition of coordinate systems and global forces acting on them is required. For this, the international standard for road vehicles ISO 8855 is used.

As shown in FIG. 3, X_{V,i}, Y_{V,i}, and Z_{V,i} are the unit axis systems where iϵ{1, 2, . . . n}, with the tractor unit 12 being unit number 1, and trailing units 14 getting increasingly higher numbers. Whilst only one trailing unit 14 is shown, it will be appreciated that further trailing units may be present in the vehicle combination 10. n is the total number of units of the vehicle combination 10. The rate of deviation around each axis is given by ω. The yaw rate of each unit is its rate of deviation about the Z axis, denoted ω_{z,i}. In the remainder of this disclosure, the yaw rate of a unit will be simply denoted ωᵢ.

Parameters and dimensions are defined per unit i on the vehicle combination 10, as shown in FIGS. 4A and 4B. FIG. 4A is a generic kinematic model of two units i−1 and i of a vehicle combination 10. Each unit has a wheelbase Lᵢ. The coupling point between units i−1 and i is denoted Cᵢ₋₁. A distance between a rear axle of a unit i−1 and the coupling point to the unit i is denoted bᵢ₋₁. Note that point Cᵢ₋₂ is the front axle of tractor in the case that i=2.

The angle between the longitudinal axes of consecutive units is known as the articulation angle θ. In particular, the articulation angle θ between units i and i+1 is given by θ_{i,i+1} (i.e. the articulation angle θ between the tractor unit 12 and the first trailing unit 14 is denoted θ_{1,2}). The rate of change of the articulation angle, known as the articulation angular rate, is denoted by \dot{θ}. The yaw angle of a unit is denoted ψᵢ. The sideslip angle of a unit is denoted βᵢ. β_{i-1,c} is the sideslip angle of unit i−1 at the coupling point. The longitudinal velocity of a unit is taken from a rear axle of the unit and is denoted vᵢᵣ. The units have a road wheel angle δᵢ (shown in FIG. 4B) which is the angle between the direction of the wheels and the longitudinal direction of the unit.

In Error! Reference source not found. B, a kinematic model of a vehicle combination 10 comprising a tractor unit 12 and a trailing unit 14 is shown. The tractor unit has wheelbase L₁ and the trailing unit 14 has wheelbase L₂. The tractor unit 12 and the trailing unit 14 are connected via a moment free articulation point C₁. The distance from the rear axle of the tractor unit 12 to the coupling point C₁ is denoted as b₁. The tractor unit 12 has a front axle velocity denoted v_{if}. The other parameters are given the appropriate subscripts as discussed above. The front axle of the tractor unit 14 is steered with a road wheel angle δ, which is determined by the steering controls of the tractor unit 14.

The vehicle is modelled as a single-track model, i.e., left and right wheels on a given axle are considered together. The real units can have axle groups with several axles, but in the model they are considered together, i.e., the tractor unit 14 is modelled with only one front and one rear wheel and the trailing unit 14 is modelled with only one wheel. The tyres are modelled with no tyre slip, which means that the tyre velocity vectors v₁ᵣ, v_{1f} and v₂ᵣ, are directed along the centreline of the tyres.

The inventors have determined that the yaw instabilities shown in FIGS. 2A and 2B can be described by the time response of longitudinal slip of the wheels of the vehicle combination. The longitudinal slip is the relative motion between a tyre and the road surface it is moving on. The longitudinal slip can be defined as:

$$slip = \frac{{r}_{ik} {Ω}_{ik} - {v}_{xik}}{{v}_{xik}}$$

where rᵢₖ is the radius of wheel k of unit i radius at the point of contact with the road, Ωᵢₖ is the longitudinal component of the rotational speed of the wheel k of unit i, and vₓᵢₖ is the longitudinal speed of the wheel k of unit i.

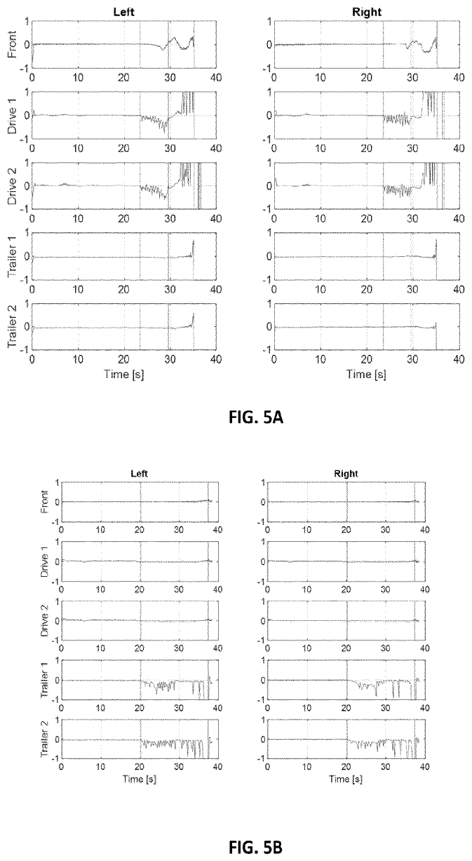

Examples of these time responses are shown in FIGS. 5A and 5B. The time responses are based on real tests of a vehicle combination 10 comprising a tractor unit 12 and a trailing unit 14. The tractor unit 12 has three axles (Front, Drive 1, Drive 2) and the trailing unit 14 has two axles (Trailer 1, Trailer 2). The vehicle combination 10 is protected against a severe jack knife by means of a jack-knife protection cable connected between the tractor unit 12 and the trailing unit 14. The jack-knife protection cables allow maximum of 60° articulation angle, at which point the cable tightens and prevents a catastrophic jack-knife. The time responses in FIGS. 5A and 5B are shown up to the time at which the vehicle combination 10 reaches a standstill.

FIG. 5A is a plot of the longitudinal slip for each wheel of a vehicle combination 10 for a jack-knife case. The vertical line at 23 s indicates the time instant at which braking started, and the vertical line at 29.5 s indicates the time instant at which braking stopped. As can be seen, the longitudinal slip of the wheels of the tractor unit 12 becomes significantly unstable and tends negatively after braking starts. Therefore, the longitudinal slip of the wheels of the tractor unit 12 is a particularly good indicator of a jack-knife. This does not require any monitoring of the trailing unit 14 or the articulation angle θ, meaning that this finding can be applied to vehicle combinations with trailers lacking sensors.

FIG. 5B is a plot of the longitudinal slip for each wheel of a vehicle combination 10 for a trailer swing case. The vertical line at 20 s indicates the time instant at which braking started, and the vertical line at 37.5 s indicates the time instant at which braking stopped. As can be seen, the longitudinal slip of the wheels of the trailing unit 14 becomes significantly unstable and tends negatively after braking starts. Therefore, the longitudinal slip of the wheels of the trailing unit 14 is a particularly good indicator of trailer swing. This does not require any monitoring of the tractor unit 12 or the articulation angle θ.

With this in mind, a method is proposed in which a longitudinal slip of at least one wheel of at least one unit of the vehicle combination 10 is monitored with respect to certain limits to determine if the vehicle combination 10 is operating in a safe manner. In particular, thresholds for the longitudinal slip can be used to determine whether the vehicle combination 10 is operating safely. The thresholds can be fixed or a function of a current operating state of the vehicle combination. Furthermore, if a particular mechanism is activated in response to longitudinal slip in the wheels, this can also be an indication of a yaw instability. Such mechanisms may include an anti-lock braking system (ABS) for braking, for example including a slip control system and other types of control strategies, a traction control system for propulsion, and/or an electronic stability program (ESP) for stability control.

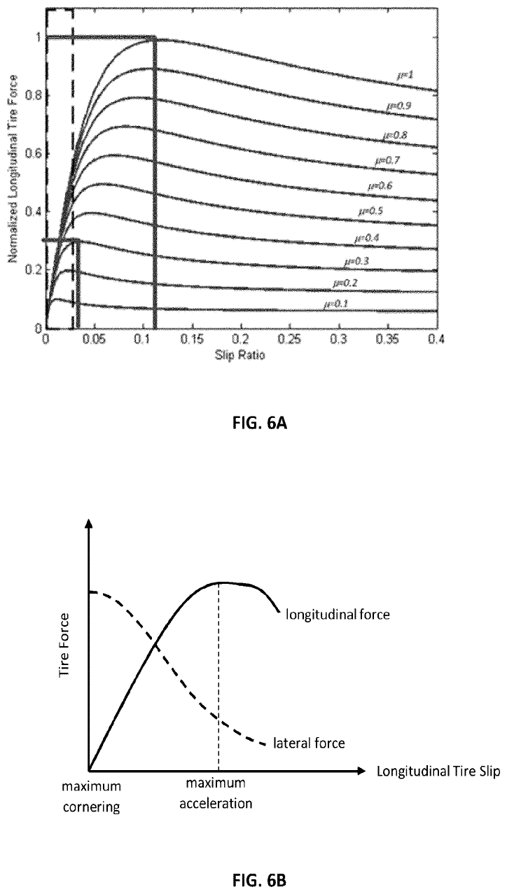

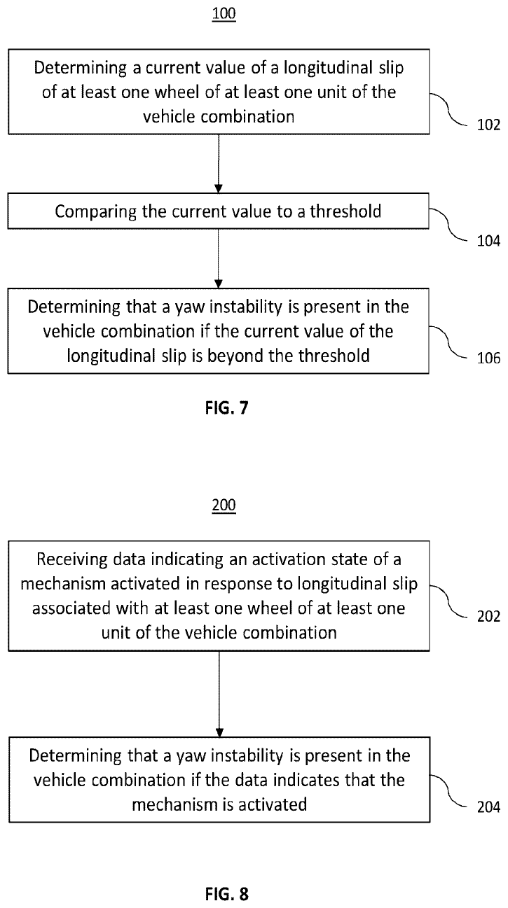

Longitudinal slip is dependent on a number of factors, such as road friction. FIG. 6A shows a plot of longitudinal tyre force on the ground against the slip ratio for different values of the road friction coefficient μ, taken from Zhang X, Göhlich D (2017) “A hierarchical estimator development for estimation of tire-road friction coefficient” PLOS ONE 12(2): e0171085. The tyre force is related to the slip ratio using a tyre model. As can be seen, the longitudinal tyre force increases as the road friction increases. Furthermore, the longitudinal tyre force reaches a maximum value as the slip ratio increases from zero, before decreasing. This means that after achieving this much slip, no more force can be created and the wheels will likely be either be locked (while braking) or will spin (during propulsion). This maximum value can be helpful when determining how much longitudinal slip should be allowed, as we be described in relation to FIG. 7.

FIG. 6B shows a plot of longitudinal and lateral tyre force on the ground against the slip ratio. As can be seen, the lateral force that can be generated decreases with increasing slip. However, for a larger lateral acceleration, a larger lateral force is required. Therefore, the slip threshold for yaw instability detection can be decreased with higher lateral acceleration. The same principle can be applied to road wheel angle and articulation angle, as they typically get larger for larger lateral acceleration.

FIG. 7 is a flow chart illustrating a method 100 of detecting a yaw instability in a vehicle combination, such as the vehicle combination 10, comprising a tractor unit 12 and at least one trailing unit 14.

The method 100 comprises, at step 102, determining a current value of a longitudinal slip of at least one wheel of at least one unit of the vehicle combination 10. The current value of the longitudinal slip can be determined in a number of ways. For example, it can be determined using one or more sensors on the vehicle combination that gives values required to calculate the longitudinal slip. This may be a wheel speed sensor, which typically all wheels of a vehicle combination will have. The vehicle speed can be estimated in many ways, such as with a Kalman filter or similar in combination with a vehicle model and sensor readings, including accelerometers, yaw rate sensors, wheel speed sensors, propulsion shaft speed sensors, brake pressures, and engine torque estimations.

Once the longitudinal slip values for the wheels are determined, a single value can be selected. The current value can be the longitudinal slip from a single wheel, a single axle, a maximum longitudinal slip value from a plurality of wheels, or an average of the longitudinal slip values from a plurality of wheels. Other selections will be readily envisaged. In some embodiments, an absolute value of the longitudinal slip can be used. In other embodiments, a positive value of the longitudinal slip can be used for propulsion, and a negative value of the longitudinal slip can be used for braking.

At step 104, the current value of the longitudinal slip is compared to a threshold. The threshold may be a fixed threshold, determined for example based on model or experimental data, or a variable threshold, determined for example based on the current operating state of the vehicle combination 10. For example, a number of manoeuvres can be logged both with and without yaw instabilities. These can be performed with many different speeds, lateral accelerations, frictions, slopes, load distributions, road wheel angles, etc. These can then be evaluated and the thresholds can be tuned, if possible as a function of vehicle states and/or environmental variables. Alternatively, a machine learning model can be trained to tune the thresholds.

To determine a fixed threshold, the relationship between slip ratio and road surface friction coefficient shown in FIG. 6A can be used. As discussed above, the longitudinal tyre force reaches a maximum value at a given slip ratio. A threshold for longitudinal slip can be set at a certain percentage of that slip ratio, i.e. something less than the slip that corresponds to maximum force. As the maximum longitudinal tyre force occurs at lower slip ratios for lower friction surfaces, more slippery surfaces would have lower limits on longitudinal slip. For example, for μ=1 (e.g. asphalt), the maximum force is obtained at a slip ratio of around 0.12, whereas for μ=0.3 (e.g. ice or snow), the maximum force is obtained at a slip ratio of around 0.03. The friction coefficient of a given surface can be determined using a friction estimator as known in the art.

The percentage used to determine the threshold can be determined based on experimental or model data relating to the vehicle combination 10. This can be done using real tests, computer model simulations, a machine learning model, or other suitable means known in the art, as discussed above. In some embodiments, different percentages can be used for different wheels, for example based on a load on the axle. For example, the longitudinal slip threshold can be 70% of the slip ratio for the maximum longitudinal tyre force. Taking a road surface friction coefficient of 1 (e.g. asphalt), for example, this would give a limit for the slip ratio of around 0.1, whereas for a road surface friction coefficient of 0.3 (e.g. ice or snow), this would give a limit for the slip ratio of around 0.02. However, for low friction, the peaks are not particularly dominant and occur at low slip ratios. Therefore, beyond the maximum tyre force, there is not a great loss of longitudinal force capability. Therefore, slip controllers do not normally try to maintain the slip at a low value (e.g. 0.02 for snow surfaces), as they are not usually aware of what type of surface is being driven on. Instead, they try to maintain the slip around 0.1. Therefore, the threshold can be set higher for low friction cases, for example 0.07 for ice or snow.

The threshold can also be adjusted based on other factors, such as road slope and load distribution. For example, for tractor braking and trailer propulsion, downhill slopes are riskier, and so the threshold can be smaller for such conditions. Furthermore, axles with lighter loads may have larger limits, or may not be limited at all. For example, if two axles of a trailing unit are heavily loaded, and a third is lightly loaded, then only the heavily loaded axles need to be limited and monitored. Alternatively, all axles may be monitored with weight factors for the limits, where the weights for the lightly loaded axles are lower. In some embodiments, the weight factors can be linearly proportional to the axle load. Axle configuration can also be considered. For example, if a unit has only one axle and it is slipping, we can detect an instability, but if a unit has three axles but only one is slipping, no instability may be detected. The axle configuration can be considered as a part of the load distribution, or can be considered individually.

To determine a variable threshold based on the current operating state of the vehicle combination 10, a baseline value for the threshold can be related to one or more parameters of a current operating state. The baseline value can be set based on a fixed threshold, as discussed above. The baseline threshold can be varied with respect to vehicle states such as lateral acceleration a_{y} of the tractor unit 12 and/or the at least one trailing unit 14, road wheel angle δ of the tractor unit 12, a road profile, and/or an articulation angle θ of consecutive units. In particular, the threshold can decrease as the values of these parameters. That is to say, as lateral acceleration a_{y}, road wheel angle δ and/or articulation angle θ increase, the threshold is reduced. For example, for zero lateral acceleration, the threshold can be maintained relatively high, for example 0.12. For a larger lateral acceleration (e.g., 0.4 g) the threshold can be decreased to, for example. 0.07. This is because at high values of these parameters, the onset of an instability is more likely than at lower values. These parameters can be used individually or in combination. For example, if the vehicle combination is in a curve, all three parameters will be non-zero and relatively high, and even a small change in longitudinal slip can be used to detect any potential instability. In some embodiments, the longitudinal slip can be monitored together with other parameters, such as lateral acceleration, road wheel angle, or articulation angle. Each of these parameters are relatively high during a turn. For straight line driving, more slip may be allowed than in a turn. Therefore, if the lateral acceleration, road wheel angle, and/or articulation angle is high, the limit for longitudinal slip can be reduced. Similarly, the turning radius is relative low during a turn, and therefore if it is low, the limit for longitudinal slip can be reduced.

By determining thresholds for safe operation dynamically based on a current operating state of a vehicle combination, a more robust and responsive detection method is provided. In particular, changes in operating conditions that affect the likelihood of a yaw instability occurring, for example vehicle speed and road wheel angle, can be taken into account. This ensures that instabilities that might not be captured by a fixed safe operating envelope can be detected properly. In the opposite sense, false detections of instability captured by an inappropriately set safe operating envelope are avoided.

Returning to FIG. 7, at step 106, if the current value of the longitudinal slip is beyond the threshold, it is determined that a yaw instability is present in the vehicle combination. As shown in FIGS. 5A and 5B, the longitudinal slip becomes significantly unstable when a yaw instability is present. Therefore, a threshold can be set such that a yaw instability can be detected when it is beyond the threshold. If the current value is within the threshold, then it is determined that the vehicle combination 10 is operating safely. Therefore, to detect an upcoming or ongoing yaw instability, one can simply monitor the longitudinal slip relative to the threshold. The detection can be made if the longitudinal slip of a single wheel exceeds the threshold, the longitudinal slip of a plurality of wheels exceeds the threshold (e.g. an axle), or an average value exceeds the threshold. The selection may be even more advanced. For example, if a trailing unit 14 has four axles and only one axle has high slip, there may not be an instability as the other three axles will keep the trailing unit 14 in place. However, if numerous axles have high slip, then an instability may be likely to happen. Therefore, the detection can be made if a subset (e.g. 2 axles out of 4) of wheels of a given unit exceed a threshold x, or if a single axle exceeds a threshold y, where y>x.

Dependent on which unit is monitored, different modes of yaw instability can be determined. For example, if the current value of the longitudinal slip of at least one wheel of the tractor unit 12 is beyond the threshold, it can be determined that a jack-knife is present in the vehicle combination 10. Similarly, if the current value of the longitudinal slip of at least one wheel of the trailing unit 14 is beyond the threshold, it can be determined that trailer swing is present in the vehicle combination 10. Where values from both types of unit are used, a complete spin out can be detected.

The method 100 allows an upcoming or ongoing yaw instability in a vehicle combination to be detected with high accuracy and at an early stage. The longitudinal slip of a given wheel of a given unit gives good certainty on whether a jack-knife or trailer swing is taking place. By determining a threshold for the longitudinal slip dynamically, based on a current operating state of the vehicle combination, a more robust and responsive detection method is provided.

FIG. 8 is a flow chart illustrating another method 200 of detecting a yaw instability in a vehicle combination, such as the vehicle combination 10, comprising a tractor unit 12 and at least one trailing unit 14.

The method 200 comprises, at step 202, receiving data indicating an activation state of a mechanism activated in response to longitudinal slip associated with at least one wheel of at least one unit of the vehicle combination. For example, the mechanism may be an anti-lock braking system (ABS), a traction control system and/or an electronic stability program (ESP).

An ABS has built-in longitudinal slip limits that trigger activation of the ABS. Therefore, if the ABS is activated, it can be assumed that there is already a large negative longitudinal slip ratio. Therefore, if it is not possible or desirable to check longitudinal slip directly, an ABS signal can be used as a Boolean signal as an indicator of high negative longitudinal slip, and therefore yaw instability. Typically, ABS activation status signals are available for each wheel or axle. This provides a binary detection mechanism for high longitudinal slip, rather than setting a limit. An ABS may also include a slip control system and other types of control strategies that are activated based on the longitudinal slip, and can be used to detect instability.

Similarly, a traction control system has built-in longitudinal slip limits that trigger activation of the system for positive slip. Therefore, if the traction control system is activated, it can be assumed that there is already a large positive longitudinal slip ratio. Therefore, if it is not possible or desirable to check longitudinal slip directly, a traction control signal can be used as a Boolean signal as an indicator of high positive longitudinal slip, and therefore yaw instability. Typically, traction control activation status signals are available for each driven wheel or axle. This provides a binary detection mechanism for high longitudinal slip, rather than setting a limit.

An ESP is configured to be activated when a yaw instability exists, as well as having other functions such as anti-rollover. Therefore, if the ESP is activated, a yaw instability has likely already started. Therefore, if it is not possible or desirable to check longitudinal slip directly, an ESP signal can be used as a Boolean signal as an indicator of yaw instability. If a tractor unit ESP is activated then a jack-knife can be considered to be occurring, and if a trailing unit ESP is activated then a trailer swing can be considered to be occurring. An ESP signal may be a general ESP activation signal, or a signal specific to activation due to yaw instability.

In some embodiments, these signals can be monitored together with other parameters, such as lateral acceleration, road wheel angle, or articulation angle. Each of these parameters are relatively high during a turn. For straight line driving, more slip may be allowed than in a turn. Therefore, if the lateral acceleration, turning radius, road wheel angle, and/or articulation angle is low, the activation of one of these systems may be disregarded. Similarly, the turning radius is relative low during a turn, and therefore if it is low, the activation of one of these systems may be disregarded.

Returning to FIG. 8, at step 204, if the data indicates that the ABS, the traction control system and/or the ESP is activated, it is determined that a yaw instability is present in the vehicle combination. If one or more of these mechanisms is activated, there is a high probability that a yaw instability is present. Therefore, to detect an upcoming or ongoing yaw instability, one can simply monitor the activation of these mechanisms.

Dependent on which unit is activated, different modes of yaw instability can be determined. For example, if one or more of these mechanisms is activated on the tractor unit 12, it can be determined that a jack-knife is present in the vehicle combination 10. Similarly, if one or more of these mechanisms is activated on the trailing unit 14, it can be determined that trailer swing is present in the vehicle combination 10. Where if one or more of these mechanisms is activated on both types of unit, a complete spin out can be detected.

The method 200 allows an upcoming or ongoing yaw instability in a vehicle combination to be detected with high accuracy and at an early stage. The activation of these mechanisms gives good certainty on whether a jack-knife or trailer swing is taking place.

A tyre model can be used in combination with the methods disclosed above. The tyre model can be that disclosed in the Vehicle Dynamics Compendium from Bengt Jacobson et al, Vehicle Dynamics Group, Division Vehicle and Autonomous Systems, Department of Mechanics and Maritime, Chalmers University of Technology, www.chalmers.se. For example, the tyre model may take into account the cornering stiffness of the tyres of the vehicle combination, which is a value defining tires how much lateral force is created for a certain sideslip angle of the tyre.

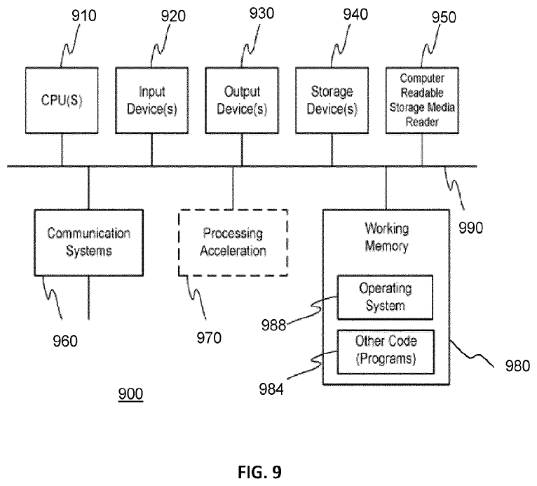

FIG. 9 is a block diagram illustrating an exemplary computer system 900 in which embodiments of the present disclosure may be implemented. This example illustrates a computer system 900 such as may be used, in whole, in part, or with various modifications, to provide the functions of the disclosed system. For example, various functions may be controlled by the computer system 900, including, merely by way of example, simulating, determining, classifying, receiving, etc.

The computer system 900 is shown comprising hardware elements that may be electrically coupled via a bus 990. The hardware elements may include one or more central processing units 910, one or more input devices 920 (e.g., a mouse, a keyboard, etc.), and one or more output devices 930 (e.g., a display device, a printer, etc.). The computer system 900 may also include one or more storage devices 940. By way of example, the storage devices 940 may be disk drives, optical storage devices, solid-state storage device such as a random-access memory (“RAM”) and/or a read-only memory (“ROM”), which can be programmable, flash-updateable and/or the like.

The computer system 900 may additionally include a computer-readable storage media reader 950, a communications system 960 (e.g., a modem, a network card (wireless or wired), an infra-red communication device, Bluetooth™ device, cellular communication device, etc.), and a working memory 980, which may include RAM and ROM devices as described above. In some embodiments, the computer system 900 may also include a processing acceleration unit 970, which can include a digital signal processor, a special-purpose processor and/or the like.

The computer-readable storage media reader 950 can further be connected to a computer-readable storage medium, together (and, optionally, in combination with the storage devices 940) comprehensively representing remote, local, fixed, and/or removable storage devices plus storage media for temporarily and/or more permanently containing computer-readable information. The communications system 960 may permit data to be exchanged with a network, system, computer and/or other component described above.

The computer system 900 may also comprise software elements, shown as being currently located within the working memory 980, including an operating system 988 and/or other code 984. It should be appreciated that alternative embodiments of a computer system 900 may have numerous variations from that described above. For example, customised hardware might also be used and/or particular elements might be implemented in hardware, software (including portable software, such as applets), or both. Furthermore, connection to other computing devices such as network input/output and data acquisition devices may also occur.

Software of the computer system 900 may include code 984 for implementing any or all of the function of the various elements of the architecture as described herein. For example, software, stored on and/or executed by a computer system such as the system 900, can provide the functions of the disclosed system. Methods implementable by software on some of these components have been discussed above in more detail.

1. A method of detecting a yaw instability in a vehicle combination, the vehicle combination comprising a tractor unit and at least one trailing unit, the method comprising:
determining a current value of a longitudinal slip of at least one wheel of at least one unit of the vehicle combination;
comparing the current value of the longitudinal slip to a threshold; and
if the current value is beyond the threshold, determining that an upcoming or ongoing yaw instability is present in the vehicle combination;
wherein the threshold is a fixed threshold determined based on the slip ratio of the wheel at a maximum longitudinal tire force, or a variable threshold determined based on the inverse of a current value of a lateral acceleration of the tractor unit, a lateral acceleration of the trailing unit, a road wheel angle of the tractor unit, a road wheel angle of the trailing unit, and/or an articulation angle of consecutive units.

2. The method of claim 1, comprising determining the current value of the longitudinal slip using one or more sensors on the vehicle combination.

3. The method of claim 1, wherein the current value of the longitudinal slip is a maximum longitudinal slip value or an average longitudinal slip value determined from longitudinal slip values from a plurality of wheels.

4. The method of claim 1, comprising determining that an upcoming or ongoing yaw instability is present in the vehicle combination if the current values of longitudinal slip of a plurality of wheels are all beyond the threshold.

5. (canceled)

6. The method of claim 1, wherein the slip ratio is dependent on the tyre type and/or a road surface friction coefficient.

7. (canceled)

8. The method of claim 1, comprising determining that a jack-knife is present in the vehicle combination if the current value of the longitudinal slip of at least one wheel of the tractor unit is beyond the threshold.

9. The method of claim 1, comprising determining that trailer swing is present in the vehicle combination if the current value of the longitudinal slip of at least one wheel of the trailing unit is beyond the threshold.

10-13. (canceled)

14. A non-transitory computer-readable medium having stored thereon instructions that, when executed by one or more processors cause execution of the method steps according to claim 1.
